(19) United States
(12) Patent Application Publication
(10) Pub. No.: US 2016/0059702 A1
(43) Pub. Date: Mar. 3, 2016

(54) DISCHARGE CONTROL DEVICE

(71) Applicant: KEIHIN CORPORATION, Tokyo (JP)

(72) Inventor: Ryutaro Minesawa, Shioya-gun (JP)

(73) Assignee: KEIHIN CORPORATION, Tokyo (JP)

(21) Appl. No.: 14/795,989

(22) Filed: Jul. 10, 2015

(30) Foreign Application Priority Data
Aug. 28, 2014 (JP) 2014-174291

(51) Int. Cl. B60L 3/00; B60R 16/06; B60R 16/023; B60L 11/00

(52) U.S. Cl. CPC B60L 3/0007; B60L 11/005; B60R 16/06; B60R 16/023

(57) ABSTRACT

A discharge control device controls a discharge bypass circuit for discharging a charge in a capacitor provided in a drive device for a motor that rotates wheels of a vehicle at time of a collision of the vehicle. The discharge control device includes a control circuit that makes the discharge bypass circuit perform discharge for a period set on the basis of a time for which the wheels rotate due to inertia at the time of the collision of the vehicle.

### CROSS REFERENCE TO RELATED APPLICATION

The present application claims priority under 35 U.S.C. §119 to Japanese Patent Application No. 2014-174291 filed in the Japan Patent Office on Aug. 28, 2014, the entire content of which is hereby incorporated by reference.

### TECHNICAL FIELD

The present invention relates to, for example, a discharge control device.

### BACKGROUND

In electric cars and hybrid cars, high-voltage power is stored in a capacitor disposed in a drive device to drive a motor at the time of driving and the power stored in the capacitor is discharged safely and rapidly by a rapid discharge circuit if a collision occurs. The rapid discharge circuit includes a discharge bypass circuit that is a circuit obtained by connecting a resistor and a switching element in series and is connected in parallel to the capacitor for example. At the time of a collision, the rapid discharge circuit causes the discharge safely and rapidly by turning the switching element to the on-state to consume the power stored in the capacitor by the resistor. One form of the rapid discharge circuit is disclosed in Japanese patent laid-open publication No. 2013-187941 (“'941”).

### SUMMARY

In JP '941, among the rapid discharge circuits are one having a form in which a discharge control device for controlling the switching element of the above-described discharge bypass circuit is provided and power to this discharge control device is supplied from the above-described drive device. In the case of this form, there is a possibility that, at the time of a collision, induced power is generated in a motor rotationally driven by wheels that keep on rotating due to inertia and is applied to the discharge control device via the drive device and the discharge control device is broken.

One aspect of the present application protects the discharge control device from the induced power generated in the motor due to the rotation of wheels at the time of a vehicle collision.

According to one embodiment, a discharge control device that controls a discharge bypass circuit for discharging a charge in a capacitor provided in a drive device for a motor that rotates wheels of a vehicle at the time of a collision of the vehicle includes a control circuit that makes the discharge bypass circuit perform discharge for a period set on the basis of a time for which the wheels rotate due to inertia at the time of the collision of the vehicle.

According to another embodiment, the control circuit described above has a flip-flop circuit that outputs an output signal that is a discharge instruction to the discharge bypass circuit and an inverted signal of the output signal at the time of the collision of the vehicle, and stops output of the output signal when a reset signal is input to the flip-flop circuit, and a delay circuit that outputs, to the flip-flop circuit, a signal resulting from delaying the inverted signal of the flip-flop circuit by the period as the reset signal.

According to one embodiment, the discharge control device that controls the discharge bypass circuit for discharging a charge in the capacitor provided in the drive device for the motor that rotates the wheels of the vehicle at the time of a collision of the vehicle includes the control circuit that makes the discharge bypass circuit perform discharge for a period set on the basis of a time for which the wheels rotate due to inertia at the time of the collision of the vehicle. This can protect the discharge control device from induced power generated in the motor due to the rotation of the wheels at the time of the collision of the vehicle.

### BRIEF DESCRIPTION OF THE DRAWINGS

The advantages of this invention will become apparent in the following description taken in conjunction with the drawings, wherein:

FIG. 1 is a functional block diagram including a discharge control device according to one embodiment of the present invention and the periphery thereof;

FIG. 2 is a functional block diagram of the discharge control device according to the embodiment of the present invention; and

FIG. 3 is a timing chart showing the operation of the discharge control device according to the embodiment of the present invention.

### DETAILED DESCRIPTION

One embodiment of the invention is described with reference to the drawings.

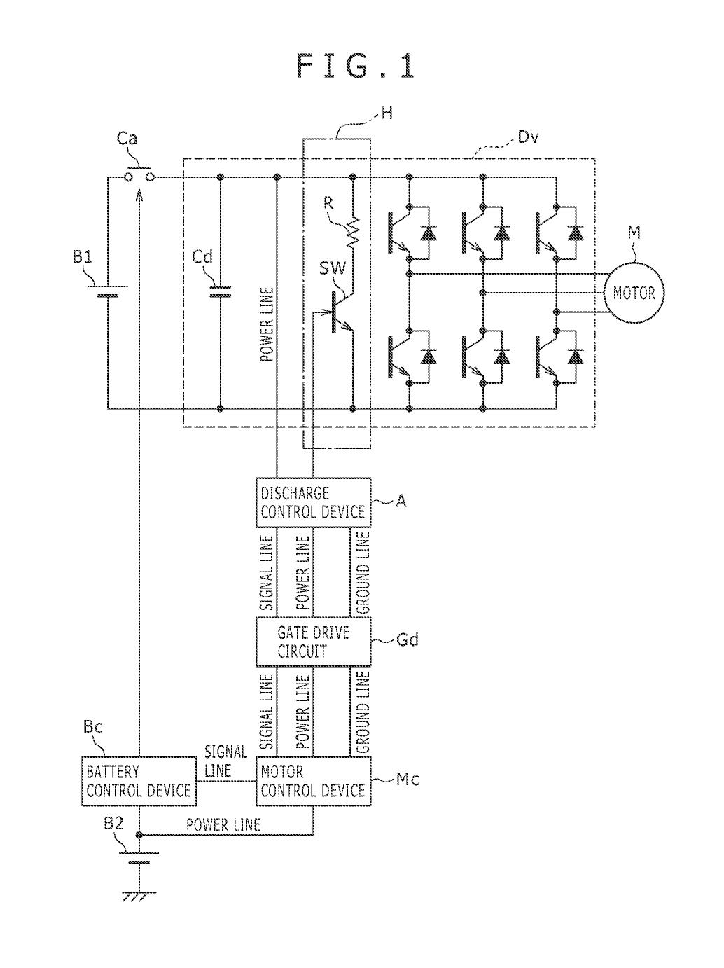

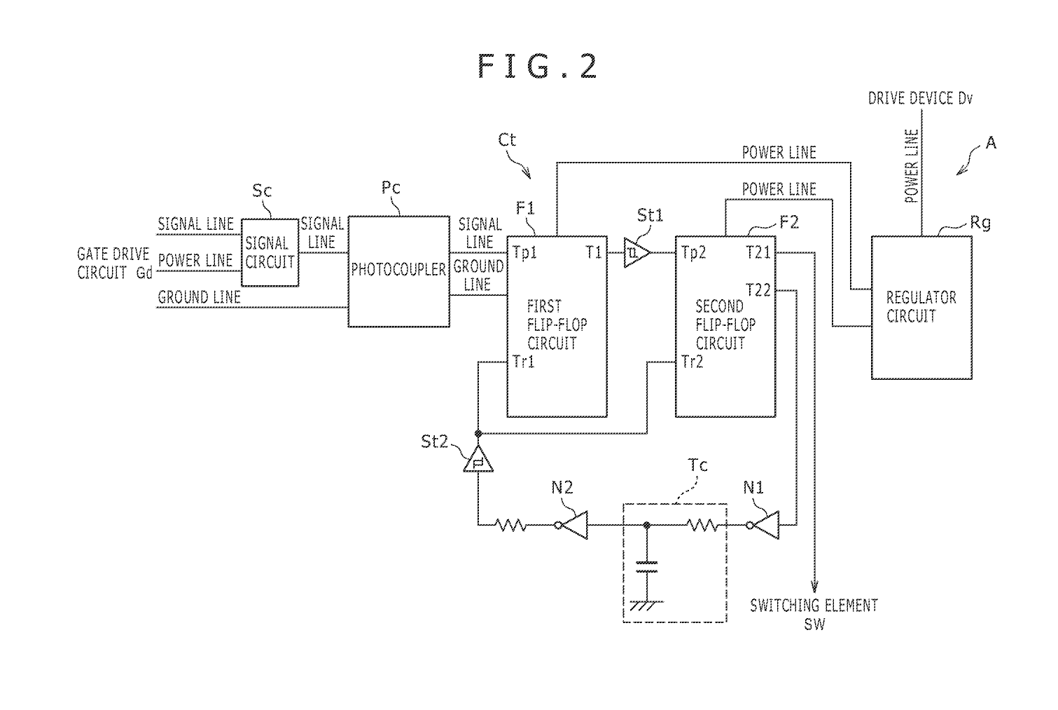

A discharge control device A according to the embodiment is mounted in a moving vehicle such as an electric car (EV: Electric Vehicle) or a hybrid car (HV: Hybrid Vehicle) and controls a discharge bypass circuit H for discharging a charge in a capacitor Cd provided in a drive device Dv for driving a motor M at the time of a collision of the moving vehicle (see FIG. 1). As shown in FIG. 2, the discharge control device A has a regulator circuit Rg, a signal circuit Sc, a photocoupler Pc, and a control circuit Ct.

The regulator circuit Rg drops the voltage of power supplied from a high-voltage battery B1 that supplies power to the drive device Dv for driving the motor M via the capacitor Cd of the drive device Dv, and supplies the resulting power to the control circuit Ct as drive power.

The signal circuit Sc is provided between a gate drive circuit Gd to be described later and the photocoupler Pc. The signal circuit Sc is connected to the gate drive circuit Gd via a signal line and a power line and is connected to the photocoupler Pc via a signal line. For example, when 0 V is input from the gate drive circuit Gd to the signal circuit Sc via the power line or a low voltage is input as a discharge instruction signal from the gate drive circuit Gd to the signal circuit Sc via the signal line, the signal circuit Sc outputs a discharge instruction signal to the photocoupler Pc.

The photocoupler Pc is an insulating element that is provided between the signal circuit Sc and the control circuit Ct and mediates communications between the signal circuit Sc and the control circuit Ct by using an optical signal. The reason why the photocoupler Pc is provided is because the voltage of the drive power of the signal circuit Sc and the gate drive circuit Gd is different from the voltage of the drive power of the control circuit Ct. For example, the control circuit Ct is driven by a higher voltage than the signal circuit Sc and the gate drive circuit Gd.

The control circuit Ct controls the discharge bypass circuit H and has a first flip-flop circuit F1, a first Schmitt trigger St1, a second flip-flop circuit F2, a first NOT circuit N1, a delay circuit Tc, a second NOT circuit N2, and a second Schmitt trigger St2.

In the first flip-flop circuit F1, an input terminal Tp1 is connected to the signal circuit Sc via the photocoupler Pc and a Q output terminal T1 is connected to an input terminal Tp2 of the second flip-flop circuit F2 via the first Schmitt trigger St1. Furthermore, a reset terminal Tr1 of the first flip-flop circuit F1 is connected to a Q-dash output terminal T22 of the second flip-flop circuit F2 via the first NOT circuit N1, the delay circuit Tc, the second NOT circuit N2, and the second Schmitt trigger St2.

When the discharge instruction signal is input from the signal circuit Sc to the input terminal Tp1 of the first flip-flop circuit F1 via the photocoupler Pc, the first flip-flop circuit F1 outputs a discharge instruction signal that is a discharge instruction to the discharge bypass circuit H from the Q output terminal T1. The discharge instruction signal output from the first flip-flop circuit F1 is converted to a one-shot pulse by the first Schmitt trigger St1 and is input to the input terminal Tp2 of the second flip-flop circuit F2 as the one-shot pulse.

The input terminal Tp2 of the second flip-flop circuit F2 is connected to the Q output terminal T1 of the first flip-flop circuit F1 via the first Schmitt trigger St1. Furthermore, in the second flip-flop circuit F2, a Q output terminal T21 is connected to a switching element SW to be described later in the discharge bypass circuit H and the Q-dash output terminal T22 is connected to the reset terminal Tr1 of the first flip-flop circuit F1 and a reset terminal Tr2 of the second flip-flop circuit F2 via the first NOT circuit N1, the delay circuit Tc, the second NOT circuit N2, and the second Schmitt trigger St2.

When the discharge instruction signal is input from the first Schmitt trigger St1 to the input terminal Tp2 of the second flip-flop circuit F2, the second flip-flop circuit F2 outputs an on-signal from the Q output terminal T21 to the switching element SW of the discharge bypass circuit H. In the discharge bypass circuit H, when the on-signal is input to the switching element SW, the switching element SW becomes the on-state and the discharge state starts. Furthermore, when outputting the on-signal from the Q output terminal T21, the second flip-flop circuit F2 outputs an inverted signal having a different potential from the on-signal from the Q-dash output terminal T22.

The first Schmitt trigger St1 is provided between the Q output terminal T1 of the first flip-flop circuit F1 and the input terminal Tp2 of the second flip-flop circuit F2. When the discharge instruction signal is input from the Q output terminal T1 of the first flip-flop circuit F1 to the first Schmitt trigger St1, the first Schmitt trigger St1 outputs the discharge instruction signal that is a one-shot pulse to the input terminal Tp2 of the second flip-flop circuit F2.

The input terminal of the first NOT circuit N1 is connected to the Q-dash output terminal T22 of the second flip-flop circuit F2 and the first NOT circuit N1 performs a logical NOT of the inverted signal input from the Q-dash output terminal T22 of the second flip-flop circuit F2, i.e. inverts the potential of the inverted signal, and outputs the resulting signal to the delay circuit Tc.

The delay circuit Tc is an integrating circuit composed of a resistor and a capacitor and delays the inverted signal input from the first NOT circuit N1 to output the resulting signal to the second NOT circuit N2. The delay time of this delay circuit Tc is set on the basis of the time for which wheels keep on rotating due to inertia at the time of a collision of the moving vehicle.

The input terminal of the second NOT circuit N2 is connected to the delay circuit Tc. The second NOT circuit N2 performs a logical NOT of the inverted signal delayed by the delay circuit Tc, i.e. inverts the potential of the inverted signal, and outputs the resulting signal to the second Schmitt trigger St2.

The input terminal of the second Schmitt trigger St2 is connected to the output terminal of the second NOT circuit N2. When the inverted signal is input from the second NOT circuit N2 to the second Schmitt trigger St2, the second Schmitt trigger St2 outputs a one-shot pulse as a reset signal to the reset terminal Tr1 of the first flip-flop circuit F1 and the reset terminal Tr2 of the second flip-flop circuit F2.

Furthermore, around the discharge control device A, a motor control device Mc, a contactor Ca, a battery control device Bc, and a low-voltage battery B2 are provided in addition to the above-described discharge bypass circuit H, motor M, drive device Dv, high-voltage battery B1, and gate drive circuit Gd (see FIG. 1).

The discharge bypass circuit H is a circuit obtained by connecting a resistor R and the switching element SW in series and is connected in parallel to the capacitor Cd of the drive device Dv. In this discharge bypass circuit H, at the time of a collision of the moving vehicle, an on-signal is input from the second flip-flop circuit F2 to the switching element SW and thereby the switching element SW becomes the on-state and the charge in the capacitor Cd provided in the drive device Dv is discharged by the resistor R.

The motor M is e.g. a three-phase motor formed of U-phase, V-phase, and W-phase. The rotating shaft thereof is connected to wheels of the moving vehicle and the motor M rotates the wheels.

The drive device Dv is formed of an inverter circuit and so forth and converts DC power supplied from the high-voltage battery B1 to three-phase drive power formed of the U-phase, V-phase, and W-phase by the inverter circuit to supply the drive power to the motor M. For example, the drive device Dv has the capacitor Cd that is a smoothing capacitor at the previous stage of the inverter circuit.

The high-voltage battery B1 supplies power to the motor M and the discharge control device A via the drive device Dv and its voltage is set to a higher voltage than the low-voltage battery B2.

The gate drive circuit Gd is provided between the motor control device Mc and the discharge control device A and outputs a discharge instruction signal to the signal circuit Sc on the basis of a discharge instruction signal input from the motor control device Mc.

The motor control device Mc is composed of a CPU (Central Processing Unit), a ROM (Read Only Memory), a RAM (Random Access Memory), and so forth. The motor control device Mc executes various kinds of operation processing on the basis of various kinds of operation control programs stored in the ROM and controls the drive device Dv, the gate drive circuit Gd, and so forth on the basis of operation processing results.

The contactor Ca is a switching element that is provided between one terminal of the capacitor Cd of the drive device Dv and one terminal of the high-voltage battery B1 and becomes the on-state or off-state on the basis of a control signal input from the battery control device Bc. For example, the control signal is input from the battery control device Bc to the contactor Ca and the contactor Ca is switched from the on-state to the off-state immediately before the switching element SW of the discharge bypass circuit H becomes the on-state.

The battery control device Bc is composed of a CPU, a ROM, a RAM, and so forth. The battery control device Bc executes various kinds of operation processing on the basis of various kinds of operation control programs stored in the ROM and controls the contactor Ca and so forth on the basis of operation processing results.

The low-voltage battery B2 supplies power to the motor control device Mc and the battery control device Bc and its voltage is set to a lower voltage than the high-voltage battery B1.

Next, the operation of the discharge control device A configured in this manner will be described.

The discharge control device A is to control the discharge bypass circuit H for discharging a charge in the capacitor Cd provided in the drive device Dv for driving the motor M at the time of a collision of the moving vehicle, and executes the following characteristic processing.

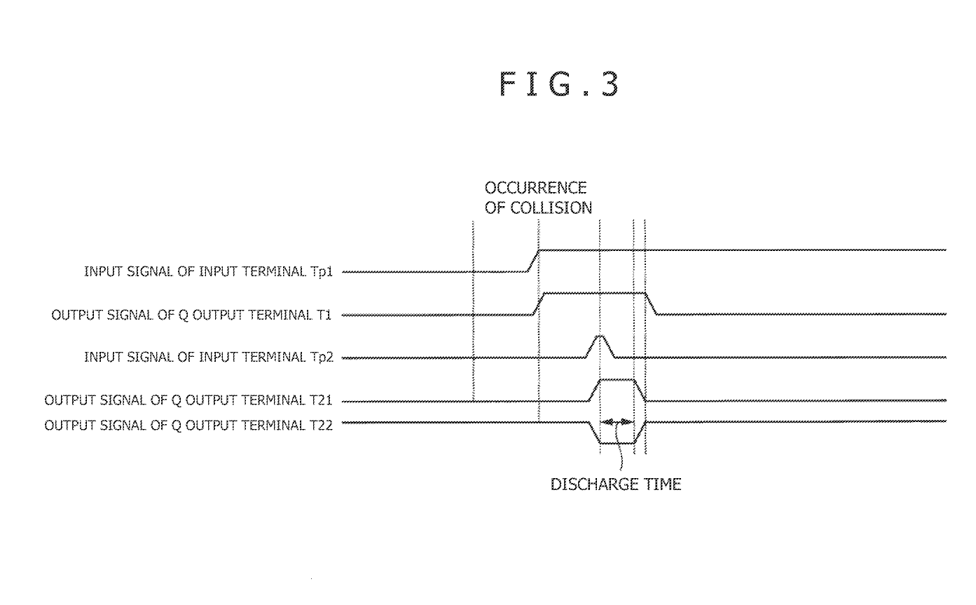

In the discharge control device A, the control circuit Ct makes the discharge bypass circuit H perform discharge for a period set on the basis of the time for which wheels keep on rotating due to inertia at the time of a collision of the moving vehicle. Specifically, first, when a discharge instruction signal is input from the signal circuit Sc to the input terminal Tp1 of the first flip-flop circuit F1 via the photocoupler Pc, the first flip-flop circuit F1 outputs a discharge instruction signal that is a discharge instruction to the discharge bypass circuit H from the Q output terminal T1 (see FIG. 3).

The period set on the basis of the time for which wheels keep on rotating due to inertia at the time of a collision of the moving vehicle is longer than a discharge time for which a charge in the normal capacitor Cd is discharged.

Furthermore, the gate drive circuit Gd outputs a discharge instruction signal that is a low voltage to the signal circuit Sc via the signal line on the basis of a discharge instruction signal input from the motor control device Mc. Furthermore, when detecting a collision of the moving vehicle, the motor control device Mc outputs the discharge instruction signal to the gate drive circuit Gd. Moreover, immediately before the discharge instruction signal is output from the motor control device Mc to the gate drive circuit Gd, a control signal is input from the battery control device Bc to the contactor Ca and the contactor Ca is switched from the on-state to the off-state. This isolates the discharge bypass circuit H from the high-voltage battery B1, which can avoid discharge of the power of the high-voltage battery B1 by the discharge bypass circuit H.

Subsequently, when the discharge instruction signal is input from the Q output terminal T1 of the first flip-flop circuit F1 to the first Schmitt trigger St1, the first Schmitt trigger St1 outputs a discharge instruction signal that is a one-shot pulse to the input terminal Tp2 of the second flip-flop circuit F2.

Then, when the discharge instruction signal is input from the first Schmitt trigger St1 to the input terminal Tp2, the second flip-flop circuit F2 outputs an on-signal from the Q output terminal T21 to the switching element SW of the discharge bypass circuit H. Furthermore, when the Q output terminal T21 outputs the on-signal, the second flip-flop circuit F2 outputs an inverted signal from the Q-dash output terminal T22 (see FIG. 3).

Then, the first NOT circuit N1 performs a logical NOT of the inverted signal input from the Q-dash output terminal T22 of the second flip-flop circuit F2, i.e. inverts the potential of the inverted signal, and outputs the resulting signal to the delay circuit Tc.

Then, the delay circuit Tc delays the inverted signal input from the first NOT circuit N1 and outputs the resulting signal to the second NOT circuit N2. The delay time of this delay circuit Tc is set corresponding to the time for which wheels keep on rotating due to inertia at the time of a collision of the moving vehicle. That is, the timing when the inverted signal is output from the delay circuit Tc is delayed by the above-described delay time.

Then, the second NOT circuit N2 performs a logical NOT of the inverted signal delayed by the delay circuit Tc, i.e. inverts the potential of the inverted signal, and outputs the resulting signal to the second Schmitt trigger St2.

Then, when the inverted signal is input from the second NOT circuit N2 to the second Schmitt trigger St2, the second Schmitt trigger St2 outputs a one-shot pulse as a reset signal to the reset terminal Tr1 of the first flip-flop circuit F1 and the reset terminal Tr2 of the second flip-flop circuit F2. When the reset signal is input to the reset terminal Tr1, the first flip-flop circuit F1 stops the output of the discharge instruction signal from the Q output terminal T1. Furthermore, when the reset signal is input to the reset terminal Tr2, the second flip-flop circuit F2 stops the output of the on-signal from the Q output terminal T21 and the output of the inverted signal from the Q-dash output terminal T22.

That is, during the period until the reset signal is input to the first flip-flop circuit F1 and the second flip-flop circuit F2, the on-signal continues to be output from the second flip-flop circuit F2 and therefore the discharge by the discharge bypass circuit H continues.

In the discharge control device A, the time from the start of the output of the on-signal by the second flip-flop circuit F2 to the input of the reset signal to the first flip-flop circuit F1 and the second flip-flop circuit F2 is a time corresponding to the delay time set for the delay circuit Tc. That is, in the discharge control device A, the control circuit Ct makes the discharge bypass circuit H perform discharge for a period set on the basis of the time for which wheels keep on rotating due to inertia at the time of a collision of the moving vehicle.

According to such an embodiment, the discharge control device A that controls the discharge bypass circuit H for discharging a charge in the capacitor Cd provided in the drive device Dv for the motor M that rotates wheels of the moving vehicle at the time of a collision of the moving vehicle includes the control circuit Ct that makes the discharge bypass circuit H perform discharge for a period set on the basis of the time for which the wheels rotate due to inertia at the time of the collision of the vehicle. This can protect the discharge control device A from induced power generated in the motor M due to the rotation of the wheels at the time of the collision of the vehicle.

Although the embodiment of the present invention is described above, the present invention is not limited to such an embodiment and e.g. the following modification will be possible.

The embodiment may be mounted in a device other than the moving vehicle.

It should be understood by those skilled in the art that various modifications, combinations, sub-combinations and alterations may occur depending on design requirements and other factors insofar as they are within the scope of the appended claims or the equivalents thereof.

We claim:

1. A discharge control device that controls a discharge bypass circuit for discharging, at time of a collision of a vehicle, a charge in a capacitor provided in a drive device for a motor that rotates wheels of the vehicle, the discharge control device comprising:
a control circuit that makes the discharge bypass circuit perform discharge for a period set on the basis of a time for which the wheels rotate due to inertia at the time of the collision of the vehicle.

2. The discharge control device according to claim 1, wherein the control circuit comprises:
a flip-flop circuit that outputs an output signal that is a discharge instruction to the discharge bypass circuit and an inverted signal of the output signal at the time of the collision of the vehicle, and stops output of the output signal when a reset signal is input to the flip-flop circuit; and
a delay circuit that outputs, to the flip-flop circuit, a signal resulting from delaying the inverted signal of the flip-flop circuit by the period as the reset signal.

3. The discharge control device according to claim 1, wherein the drive device supplies power to the motor and the discharge control device.

4. The discharge control device according to claim 3, wherein the drive device is electrically connected to the motor and the discharge control device.

5. The discharge control device according to claim 4, wherein the discharge bypass circuit discharges induced power generated in the motor when the wheels rotate due to the inertia at the time of the collision of the vehicle.

6. The discharge control device according to claim 1, wherein the period is longer than a discharge time for which the charge in the capacitor is fully discharged.

7. The discharge control device according to claim 2, wherein the delay circuit receives the inverted signal from the flip-flop circuit.

8. A vehicle comprises the discharge control device according to claim 1.
